(19) United States
(12) Patent Application Publication
(10) Pub. No.: US 2025/0328315 A1
(43) Pub. Date: Oct. 23, 2025

(54) SCRIPT GENERATION SYSTEM AND METHOD

(71) Applicant: Bereej Technologies Private Limited, Pune (IN)

(72) Inventors: Sudeep Mohan KHIRE, Pune (IN); Sagar Balasaheb Khatal, Pune (IN)

(21) Appl. No.: 18/637,800

(22) Filed: Apr. 17, 2024

(51) Int. Cl. G06F 8/30

(52) U.S. Cl. CPC G06F 8/30

(57) ABSTRACT

A method includes receiving, by at least one processor, a cloud computing diagram that represents a cloud computing environment, determining, by the at least one processor, at least one cloud computing component in the cloud computing environment by performing image processing on the cloud computing diagram, generating, by the at least one processor, a script and retrieving at least one template associated with the at least one cloud computing component in the cloud computing environment, preparing, by the at least one processor, the script and refining the script by ordering each of the at least one template based on user preferences, and transmitting, by the at least one processor, the script.

### BACKGROUND

Cloud computing components can be managed by users that write scripts to manage the cloud computing components and a cloud environment of the cloud computing components. The process of writing a script is a manual task that can be extremely challenging and time consuming. In addition, the script may include a number of errors that may cause major issues.

It is with these issues in mind, among others, that various aspects of the disclosure were conceived.

### SUMMARY

According to one aspect, a script generation system may include one or more client computing devices that may have a script generation application and one or more server computing devices that may have the script generation application. A user may use the client computing device to draw or prepare a cloud computing diagram that represents a cloud computing environment using the script generation application. The user may transmit the cloud computing diagram or a representation of the cloud computing diagram to the server computing device. The server computing device may receive the cloud computing diagram and determine at least one cloud computing component in a cloud computing environment by performing image processing on the cloud computing diagram. The server computing device may generate a script and retrieve at least one template associated with the at least one cloud computing component in the cloud computing environment. The at least one template associated with the at least one cloud computing component may be inserted into the script. The script may be sent back to the client computing device and may run or execute or launch the script to create or modify the cloud computing environment. This may include starting one or more virtual machines or transmitting information to the one or more virtual machines.

According to an aspect, a method includes receiving, by at least one processor, a cloud computing diagram that represents a cloud computing environment, determining, by the at least one processor, at least one cloud computing component in the cloud computing environment by performing image processing on the cloud computing diagram, generating, by the at least one processor, a script and retrieving at least one template associated with the at least one cloud computing component in the cloud computing environment, preparing, by the at least one processor, the script and refining the script by ordering each of the at least one template based on user preferences, and transmitting, by the at least one processor, the script.

According to another aspect, a system includes a computing device comprising a memory storing computer-readable instructions and at least one processor to execute the instructions to a computing device including a memory storing computer-readable instructions and at least one processor to execute the instructions to receive a cloud computing diagram that represents a cloud computing environment, determine at least one cloud computing component in the cloud computing environment by performing image processing on the cloud computing diagram, generate a script and retrieve at least one template associated with the at least one cloud computing component in the cloud computing environment, prepare the script and refine the script by ordering each of the at least one template based on user preferences, and transmit the script.

According to an additional aspect, a non-transitory computer-readable storage medium includes instructions stored thereon that, when executed by a computing device cause the computing device to perform operations, the operations including receiving a cloud computing diagram that represents a cloud computing environment, determining at least one cloud computing component in the cloud computing environment by performing image processing on the cloud computing diagram, generating a script and retrieving at least one template associated with the at least one cloud computing component in the cloud computing environment, preparing the script and refining the script by ordering each of the at least one template based on user preferences, and transmitting the script.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A is diagram of a script generation system according to an example of the instant disclosure.

FIG. 1B is an example script generated by the script generation system according to an example of the instant disclosure.

FIG. 2 is an example method of generating a script by the script generation system according to an example of the instant disclosure.

FIG. 3A is a graphical user interface of a script generation application of the script generation system according to an example of the instant disclosure.

FIG. 3B is another graphical user interface of the script generation application of the script generation system according to an example of the instant disclosure.

FIG. 4A is another graphical user interface of the script generation application of the script generation system according to an example of the instant disclosure.

FIG. 4B is another graphical user interface of the script generation application of the script generation system according to an example of the instant disclosure.

FIG. 5 shows another block diagram of the script generation system according to an example of the instant disclosure.

FIG. 6 shows a flowchart of a method of generating a script by the script generation system according to an example of the instant disclosure.

FIG. 7 shows an example of a system for implementing certain aspects of the present technology according to an example of the instant disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Cloud computing components can be managed by users that write scripts to manage the cloud computing components and a cloud environment of the cloud computing components. The process of writing a script to manage cloud computing components is a manual task that can be extremely challenging and time consuming. In addition, the script may include a number of errors that may be introduced by a human that may cause major issues. One way of managing cloud computing components may include using a Terraform script that may allow a user to provision and manage resources in a cloud computing environment. As an example, a user may create a Terraform script to create, upscale, downscale, and/or delete computing resources or computing capacity such as AWS EC2. The user may restart a database, and move the computing resources from one network to another, among other tasks. In another example, the user could create an ANSIBLE script to apply a patch to one hundred database systems and then update one hundred AWS EC2 computing resources.

There are a number of issues with the above conventional solutions. The above scripting solutions may be commonly used by information technology (IT) infrastructure management and managers including DevOps. However, scripting and writing scripts are manual tasks. Depending upon the components involved, there may be many computing resources and components such as ten servers and five databases, or even more. This may result in a script that becomes larger, more complex, and unwieldy. There are number of issues including the following issues.

Human resource issues: Scripting is similar to writing code and is technical in nature. Developers with specific skillsets are needed to write and execute scripts.

Learning curve: Depending on the IT landscape and processes, the learning curve for developers can be high.

Human-elements: Since scripting is conventionally accomplished by a human, by default, all the problems associated with human work are automatically introduced, e.g., human errors and mistakes.

Cautious approach: The scripting becomes more challenging when any changes in existing infrastructure are to be made. Slight and “minor” mistakes may have an adverse impact. A substantial amount of time is needed to create the script, and cross-check/double cross-check before the execution of the script.

State management: Scripting has some inherent issues such as maintaining various files, ensuring consistency across distributed teams, etc.

Resource abstraction: While Terraform and other conventional solutions abstract away the underlying cloud component, this may not give direct access to every feature or capability offered by a cloud provider.

Aspects of a system and method of generating a script may include one or more client computing devices that may have a script generation application and one or more server computing devices that may have the script generation application. A user may use the client computing device to draw or prepare a cloud computing diagram that represents a cloud computing environment using the script generation application. The user may transmit the cloud computing diagram or a representation of the cloud computing diagram to the server computing device. The server computing device may receive the cloud computing diagram and determine at least one cloud computing component in a cloud computing environment by performing image processing on the cloud computing diagram. The server computing device may generate a script and retrieve at least one template associated with the at least one cloud computing component in the cloud computing environment. The at least one template associated with the at least one cloud computing component may be inserted into the script. The script may be sent back to the client computing device and may run or execute or launch the script to create or modify the cloud computing environment. This may include starting one or more virtual machines or transmitting information to the one or more virtual machines.

The script generation system includes a computing device comprising a memory storing computer-readable instructions and at least one processor to execute the instructions to a computing device including a memory storing computer-readable instructions and at least one processor to execute the instructions to receive a cloud computing diagram that represents a cloud computing environment, determine at least one cloud computing component in the cloud computing environment by performing image processing on the cloud computing diagram, generate a script and retrieve at least one template associated with the at least one cloud computing component in the cloud computing environment, prepare the script and refine the script by ordering each of the at least one template based on user preferences, and transmit the script.

In one example, a method includes receiving, by at least one processor, a cloud computing diagram that represents a cloud computing environment, determining, by the at least one processor, at least one cloud computing component in the cloud computing environment by performing image processing on the cloud computing diagram, generating, by the at least one processor, a script and retrieving at least one template associated with the at least one cloud computing component in the cloud computing environment, preparing, by the at least one processor, the script and refining the script by ordering each of the at least one template based on user preferences, and transmitting, by the at least one processor, the script.

Additionally, the method may include determining the at least one template by determining a particular cloud computing component to be in the cloud computing environment by performing the image analysis on the cloud computing diagram.

In one example, the script generation system may allow a user to generate a script without having to write any code. In one example, the user may draw, prepare, or obtain a diagram using a cloud diagramming tool. The user may configure one or more cloud computing components within the diagramming tool and then may select a user interface element such as a button to generate a script. The script may be a Terraform script or another type of script such as Ansible that is generated automatically.

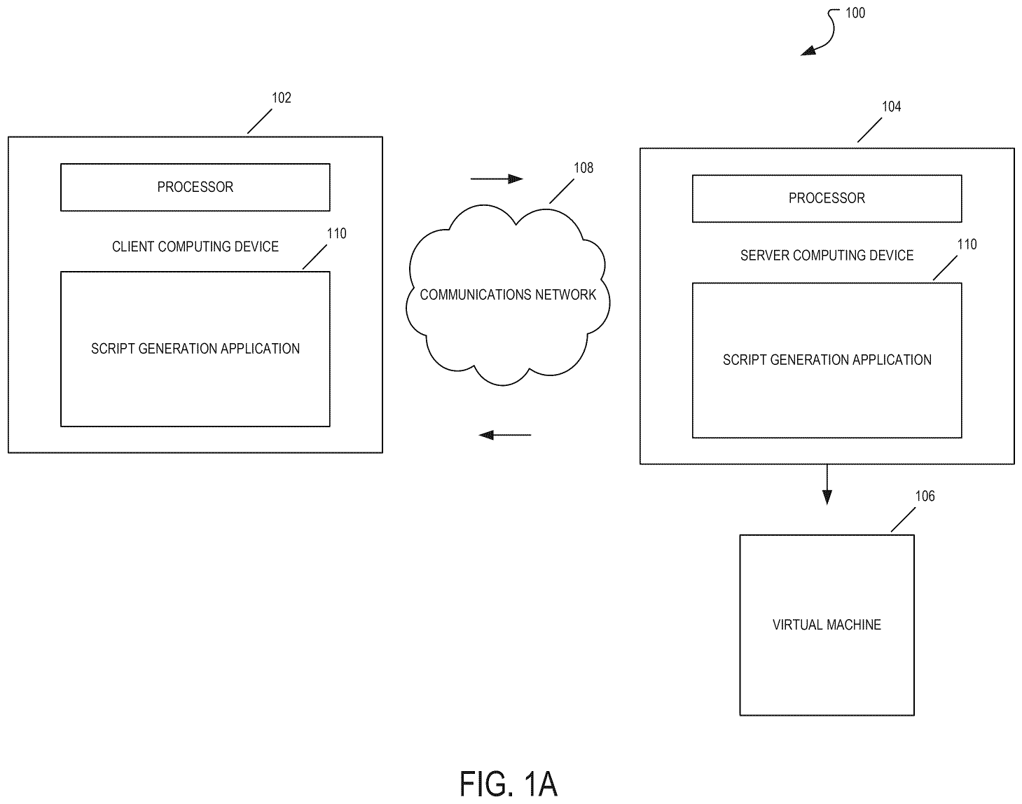

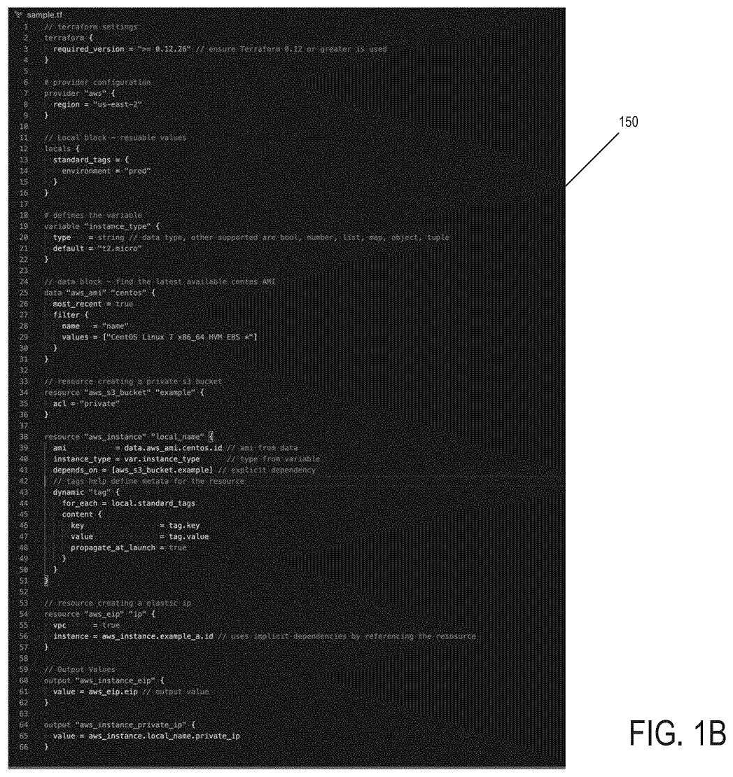

FIG. 1A is diagram of a script generation system 100 according to an example of the instant disclosure. FIG. 1B is an example script 150 generated by the script generation system 100 according to an example of the instant disclosure.

The script generation system 100 may include at least one client computing device 102 and at least one server computing device 104 that is in communication via a communication network 108. The at least one client computing device 102 and the at least one server computing device 104 may have an application or at least one component of an application, e.g., a script generation application 110. Each of the client computing device 102 and the server computing device 104 may have the application 110 or the component of the application 110. Additionally, the script generation system 100 may include one or more virtual machines or compute resources 106. The virtual machines 106 may be associated with one or more of Amazon AWS, IBM Cloud, Google Cloud Platform, Microsoft Azure, and others. In other words, the virtual machines may be provided by Cloud Platform Provider One, Cloud Platform Provider Two, Cloud Platform Three, and others.

The at least one client computing device 102 is configured to receive data from and/or transmit data to the at least one server computing device 104 through the communication network 108. Although the at least one client computing device 102 and the at least one server computing device 104 is shown as a single computing device, it is contemplated that the at least one client computing device 102 and the at least one server computing device 104 may include multiple computing devices.

The communication network 108 can be the Internet, an intranet, or another wired or wireless communication network. For example, the communication network 106 may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a Bluetooth Low Energy (BLE) network, a Bluetooth mesh network, a satellite communications network, and an IEEE 802.11 standards network, among others. Other conventional and/or later developed wired and wireless networks may also be used.

The at least one client computing device 102 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the script generation application 110. In addition, the at least one client computing device 102 further includes at least one communications interface to transmit and receive communications, messages, and/or signals.

The server computing device 104 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or a component of the script generation application 110. In addition, the server computing device 104 further includes at least one communications interface to transmit and receive communications, messages, and/or signals.

The at least one client computing device 102 can be a laptop computer, a smartphone, a personal digital assistant, a tablet computer, a standard personal computer, or another processing device. The at least one client computing device 102 may include a display, such as a computer monitor, for displaying data and/or graphical user interfaces. The at least one computing device 102 may also include an input device, such as one or more cameras, a keyboard or a pointing device (e.g., a mouse, trackball, pen, or touch screen) to enter data into or interact with graphical and/or other types of user interfaces. In an example, the display and the input device may be incorporated together as a touch screen of the smartphone or tablet computer.

The at least one client computing device 102 may display on the display a graphical user interface (or GUI). The graphical user interface may be provided by the script generation application 110. The graphical user interface enables a user of the at least one client computing device 102 to interact with the script generation application 110.

The script generation application 110 may be a component of an application and/or service executable by the client computing device 102, the server computing device 104, and one or more virtual machines 106 or one or more cloud computing resources that may be from one or more cloud computing providers such as Cloud Computing Platform One, Cloud Computing Platform Two, Cloud Computing Platform Three, and others. For example, the script generation application 110 may be a single unit of deployable executable code or a plurality of units of deployable executable code. According to one aspect, the script generation application 110 may include one component that may be a web application, a native application, and/or a mobile application (e.g., an app) downloaded from a digital distribution application platform that allows users to browse and download applications developed with mobile software development kits (SDKs) including the APPLE App Store and GOOGLE PLAY®, among others.

The system 100 may also include a relational database management system (RDBMS) or another type of database management system such as a NoSQL database system that stores and communicates data from at least one database. The data stored in the at least one database may be associated with diagrams and scripts that may be generated based on the diagrams, among other information. The data stored in the database also may be associated information associated with application analytics and improvements, among other information.

In one example, a user may prepare or draw a diagram and view and edit an automatically generated script using the application 110.

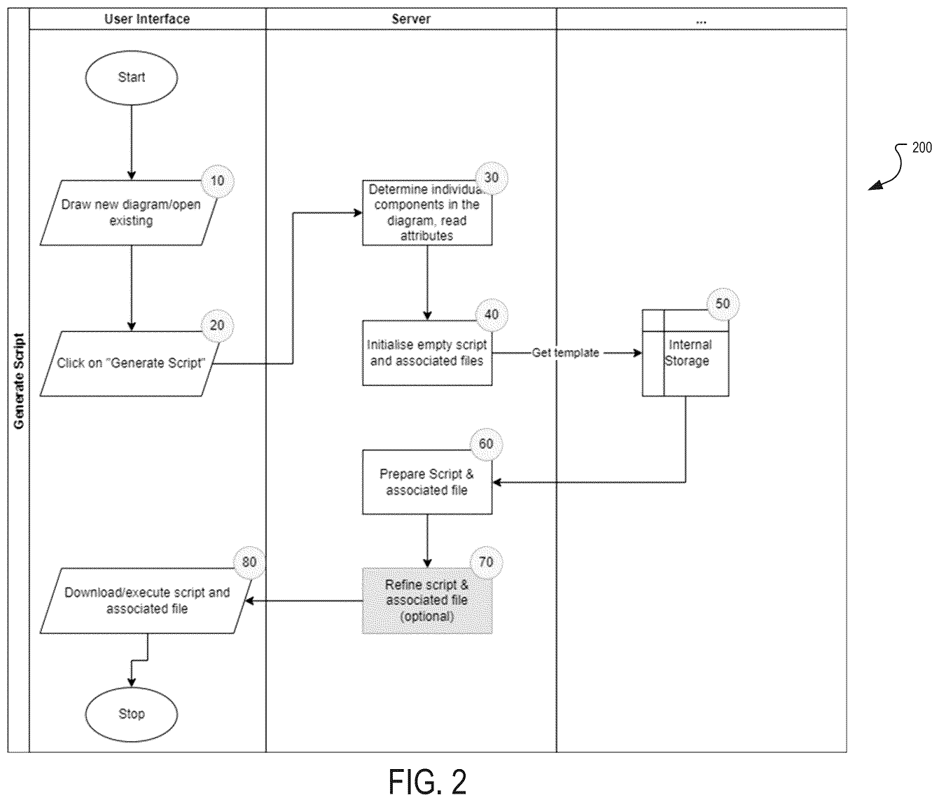

FIG. 2 is an example method 200 of generating a script 150 by the script generation system 100 according to an example of the instant disclosure. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some examples, the method 200 may include drawing a new diagram or opening an existing diagram at block 10. As an example, a user may draw a new cloud landscape diagram or open an existing diagram. In one example, the user may configure components in the diagram. In one example, the user may set AWS EC2 size to t2.micro or another size such as m7a.large, among others.

According to some examples, the method 200 may include a user selecting a generate script user interface element at block 20. As an example, the user may select a user interface element such as a button labeled “Generate Script.” The user can select the user interface element “Generate Script” to generate the script 150 on demand. As an example, the scripting will be live. A user does not need to select the user interface element. If the user does not select the user interface element, the method may generate the script 150 in realtime.

The data may have a file format such as a text file that may be Extensible Markup Language (XML), Javascript Object Notation (JSON), or Protobuf, among others. In another example, the data may be transferred from the client computing device 102 to the server computing device 104 using a socket connection, among others.

In another example, the client computing device 102 may transfer the diagram to the server computing device 104 by sending or uploading the file to a bucket associated with the server computing device 104. In one example, the user may upload one file to an S3 bucket. This may trigger the next step in the method 200.

According to some examples, the method 200 may include determining individual components in the diagram and reading or determining attributes associated with each of the components in the diagram at block 30.

In one example, the diagram may be converted into data that represents the diagram. The diagram may be one of a PDF file, a PNG file, a JPG file, and others. The diagram may be converted and processed to determine one or more individual components or objects that are present in the diagram. The image processing may include use of machine learning to understand and determine the presence of the one or more individual components or objects that are present in the diagram. As an example, a particular component may be located at a particular X, Y value in the diagram and have a particular height and length from the X, Y value.

As an example, it may be determined that there is an internet gateway that is connected to an elastic load balancer. An EC2 instance and RDS are in one subnet. There may be another set of EC2 and RDS in another subnet. The two subnets may be private. There may be two public subnets. One may have a Classless Inter-Domain Routing (CIDR) of 10.0.128.0/20 and another may have 10.0.144.0/20. After determining the components in the diagram and linkages between the components in the diagram, components may be configured such as sizes of instances and types of databases, e.g., MySQL, Oracle, etc. As an example, the diagram may be converted by determining that a particular subset of the cloud computing diagram comprises one of a logo and a graphical representation and comparing the one of the logo and the graphical representation with a library to determine the at least one cloud computing component.

In one example, data may be determined from the diagram by the client computing device 102 and may be sent to the server computing device 104. In another example, the diagram may be sent from the client computing device 102 to the server computing device 104. The server computing device 104 may determine data associated with the diagram. The server computing device may convert the diagram into one or more of XML or JSON, among other data formats.

The server computing device 104 may determine components in the diagram based on the data such as virtual machines, compute components such as EC2, databases, and others.

According to some examples, the method 200 may include initializing a script 150 that may be empty and zero or more associated files at block 40. As an example, an associated file may be generated based on a user's preferences that may be set such as a default region, e.g., us-cast-1, or a default provider, e.g., Cloud Platform Provider One or Cloud Platform Provider Two. In one example, the script 150 may be an empty script. In another example, the script 150 may be initialized including information and code associated with a first component. Other components may be added as well. In another example, the script 150 and zero or more associated files may be initialized at a same time or different times by the script generation application 110.

According to some examples, the method 200 may include obtaining one or more templates from storage at block 50. In one example, the templates may be obtained from the database. In another example, the templates may be obtained from one or more files such as TXT files, JSON files, or other types of files. In another example, the templates may be obtained from one or more variables, e.g., string s, among others. In another example, a template may be obtained from another location such as database associated with another server computing device such as a third party server computing device. In one example, the template may be obtained from a provider, a platform, or a web API, among other locations.

As an example, for a virtual machine such as EC2, the template may be similar to the following:
resource “aws_instance” “xxxxx” {
ami = “xxxxx”
instance_type = “xxxxx”
key_name = “xxxxx”
subnet_id = “xxxxx”
vpc_security_group_ids = [“xxxxx”, “xxxxx”]}

As an example, to generate a Terraform script to create an AWS EC2 instance, the system 100 may use a template. Terraform may expect virtual machine 106, e.g., EC2, creation in certain way (e.g., line 38-51 in FIG. 1B). In one example, the template may be stored in a database or another location. The storage device may store the TXT/JSON or another kind of file and the script generation application 110 may retrieve the template, and fill the information from user's diagram, e.g., size information of a virtual machine 106 such as t2.micro in line 40 of FIG. 1B.

According to some examples, the method 200 may include preparing the script 150 and the zero or more associated files at block 60. As an example, the script 150 may include one or more templates based on the one or more components as determined based on the diagram.

According to some examples, the method 200 may include refining the script 150 and the zero or more associated files at block 70. This may include performing technical and non/technical revisions to the script 150 such as adding comments to the script 150 and altering a sequence of the script 150, among others. Refining also may include performing organizational specific practices. As an example, the script 150 as shown in FIG. 1B may include a list of resources by network, e.g., the AWS instance that is shown in line 38 of the script and then IP information. A particular client or organization may have a practice of grouping AWS EC2 instances one after another and including information about other components. As an example, the script may be VPC-1, Subnet-1, EC2-1, RDS-1, VPC-2, Subnet-2, EC2-2, EC2-3. Client X may prefer a different organization or order of templates in the script such as: VPC-1, VPC-2, Subnet-1, Subnet-2, EC2-1, EC2-2, EC2-3, EDS-1. VPC may be a virtual private cloud. RDS may be a relational database service. EC2 may be related to a cloud compute capacity. In other words, a first organization or generator of the script may prefer one organizational method or order of templates in the script and a second organization or generator of the script may prefer a different organizational method or order of templates in the script.

As a result, the script 150 may be generated in different ways for different users or organizations even though it may be performing the same functions. The script 150 may be sent to the client computing device 102 and a representation of the script may be displayed by the client computing device 102.

According to some examples, the method 200 may include downloading and/or executing the script 150 by the client computing device 102 and/or the server computing device 104 at block 80. In one example, the user may download the script 150 and the zero or more associated files. The user may view the script 150, edit the script, and execute the script using the script generation application 110. In another example, the user may create a new virtual machine 106 such as a new EC2 instance and run the script 150 using the virtual machine 106. In this instance, the script generation application 110 may display output associated with the running the script 150 on the virtual machine 106. In another example, the script 150 may be executed using an existing virtual machine 106. In another example, the script 150 may be executed using a container. In another example, the script 150 may be sent to a cloud platform using a web API or software development kit (SDK) or any third party service that may allow execution of one or more commands.

In one example, there may be an option to either download the file or execute directly within script generation application 110. If the user executes the script 150 directly in the script generation application, the script 150 may be executed by the server computing device 104 and a result may be displayed to the user at run-time. One or more virtual machines or containers can be spun up or started.

This also may include executing a command on the one or more virtual machines or containers in one process or one go.

As an example, the script generation application 110 may be executed by the server computing device 104 upon selection of the user interface element. In another example, the diagram may be analyzed and processed by the client computing device 102 and the client computing device 102 may generate the script 150.

In one example, the script 150 may be a Terraform script. However, the script 150 may be another type of script such as an Ansible script, among others that may be used to manage cloud computing components.

In another example, the commands may be executed by the one or more virtual machines 106 and command output may be viewed using the script generation application 110.

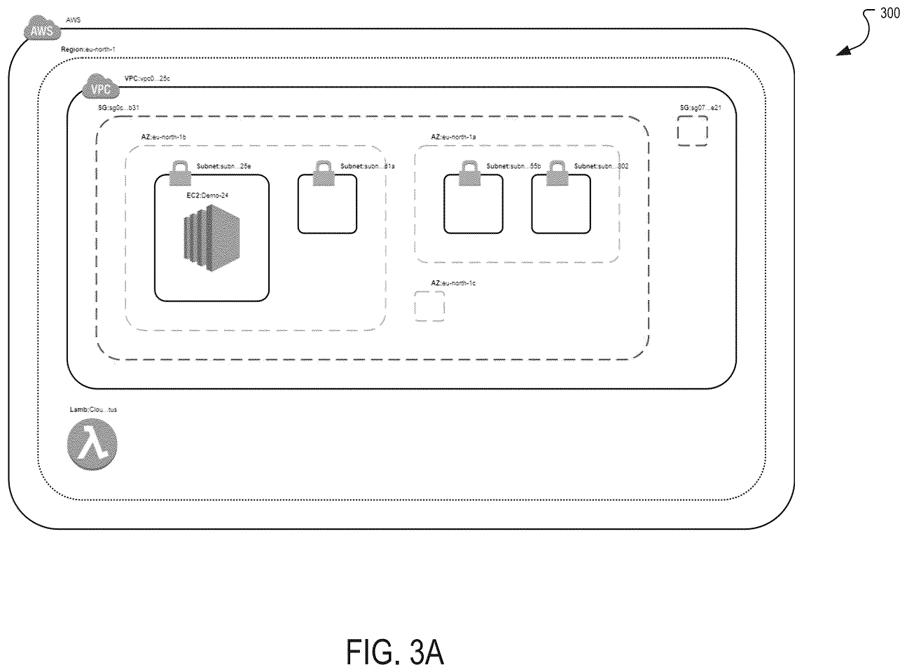

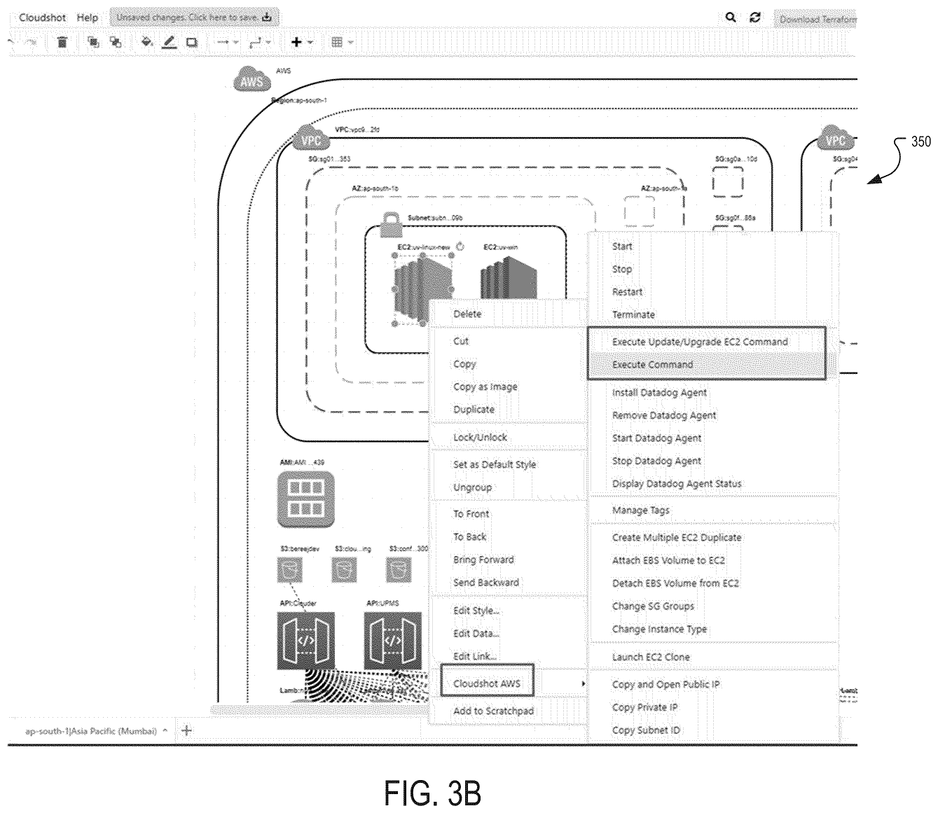

FIG. 3A is a graphical user interface 300 of the script generation application 110 of the script generation system 100 according to an example of the instant disclosure. FIG. 3B shows another graphical user interface 350 of the script generation application 110 of the script generation system 100 according to an example of the instant disclosure.

As an example, the script generation application 110 may include one or more diagramming tools to create the diagram. FIG. 3A shows an example diagram that may be drawn and configured using the script generation application 110. The user may have drawn the diagram and may automatically generate a script by selecting a user interface element to generate the script based on the diagram. The script may generated as shown below:
provider “aws” {
   region = var.aws_region
}
variable “aws_region” {
   default = “eu-north-1”
}
resource “aws_vpc” “vpc_vpc-0005b08363fd6425c” {
   cidr_block = “10.0.0.0/16”
   enable_dns_support =true
   enable_dns_hostnames =true
   tags = {“Name”= “project-vpc”}
}
resource “aws_security_group” “sg_sg-075681cbe2fe30e21” {
   name = “default”
   description = “default VPC security group”
   vpc_id = “vpc-0005b08363fd6425c”
   tags = { }
}
resource “aws_security_group” “sg_sg-0c351450d1144ab31” {
   name = “launch-wizard-1”
   description = “launch-wizard-1 created 2024-01-31T11: 47:00.845Z”
   vpc_id = “vpc-0005b08363fd6425c”
   tags = { }
}
resource “aws_subnet” “subnet_subnet-0ae2cbc52816b355b” {
   vpc_id = “vpc-0005b08363fd6425c”
   cidr_block = “10.0.0.0/20”
   availability_zone = “eu-north-1a”
   map_public_ip_on_launch = false
   tags = {“Name”= “project-subnet-public1-eu-north-1a”}
}
resource “aws_subnet” “subnet_subnet-0fb9da5cb46ff5802” {
   vpc_id = “vpc-0005b08363fd6425c”
   cidr_block = “10.0.128.0/20”
   availability_zone = “eu-north-1a”
   map_public_ip_on_launch = false
   tags = {“Name”= “project-subnet-private1-eu-north-1a”}
}
resource “aws_subnet” “subnet_subnet-0503a3d1bbbd4225e” {
   vpc_id = “vpc-0005b08363fd6425c”
   cidr_block = “10.0.144.0/20”
   availability_zone = “eu-north-1b”
   map_public_ip_on_launch = false
   tags = {“Name”= “project-subnet-private2-eu-north-1b”}
}
resource “aws_subnet” “subnet_subnet-02322b89e6c67ad1a” {
   vpc_id = “vpc-0005b08363fd6425c”
   cidr_block = “10.0.16.0/20”
   availability_zone = “eu-north-1b”
   map_public_ip_on_launch = false
   tags = {“Name”= “project-subnet-public2-eu-north-1b”}
}
resource “aws_instance” “instance_i-0f80b44cc5e78bef2” {
   ami = “ami-02d0a1cbe2c3e5ae4”
   instance_type = “t3.micro”
   key_name = “cloudshot-demo-key”
   subnet_id = “subnet-0503a3d1bbbd4225e”
   tags = {“Name”= “Demo-24”}
   vpc_security_group_ids = [“sg-0c351450d1144ab31”]
   lifecycle {
      ignore_changes = [user_data]
   }
}

In the diagramming tool, the user may select a virtual machine and select an “Execute command” as shown in FIG. 3B. As shown in FIG. 3B, a user may select the “Execute command” user interface element and a command may be fetched or obtained from the operating system of the computing device and the command may be executed. Each operating system may have a different command.

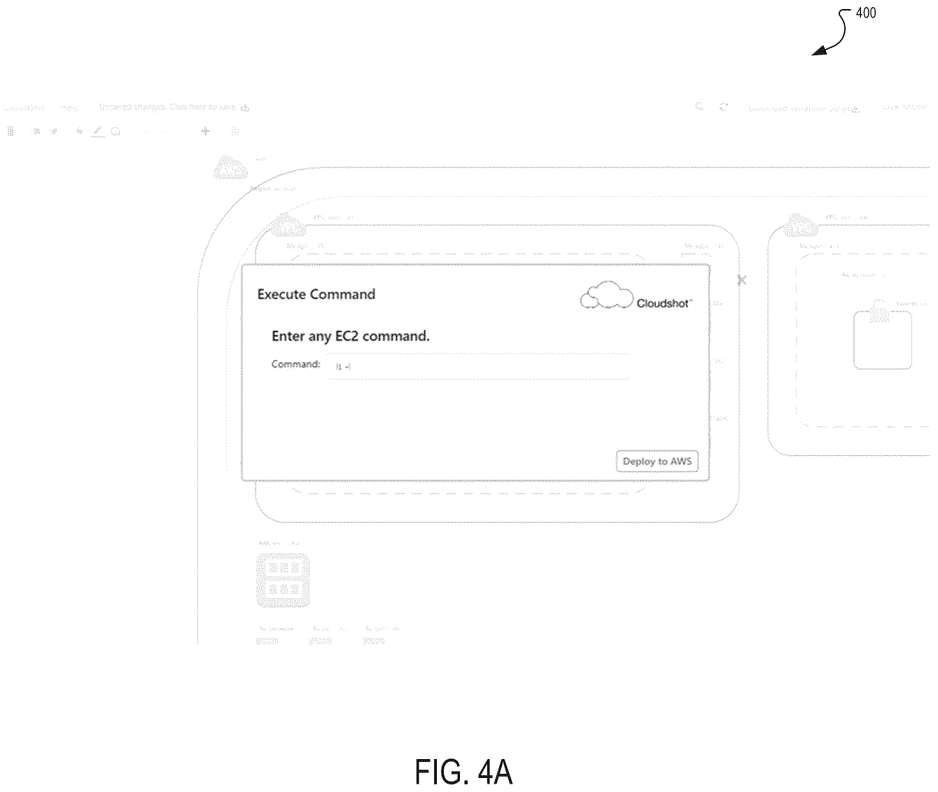

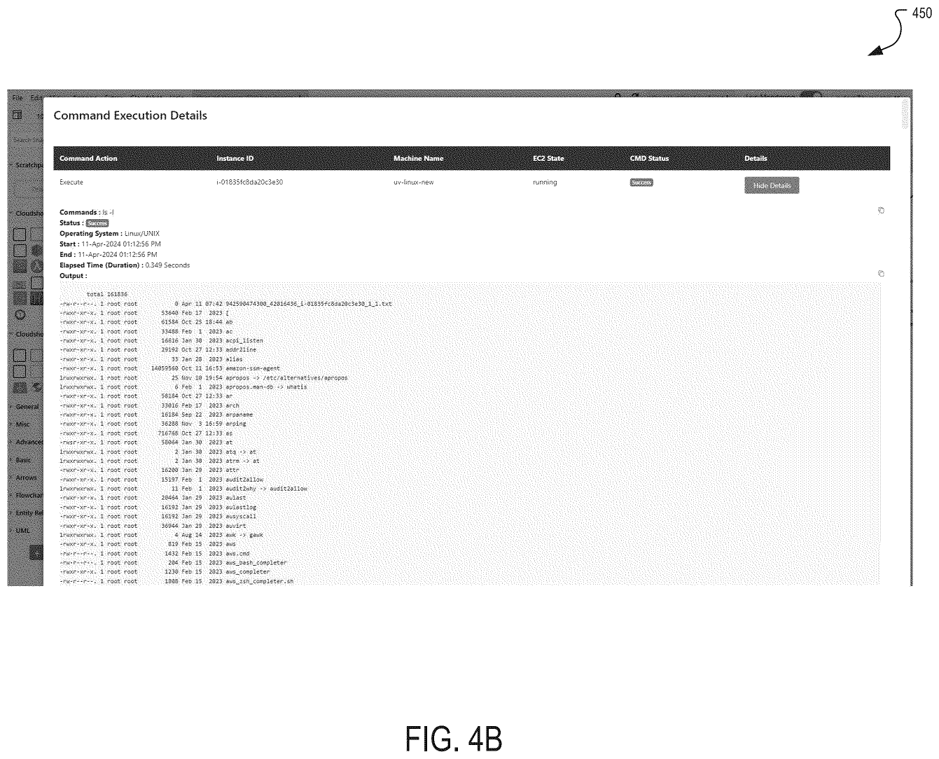

FIG. 4 is another graphical user interface 400 of the script generation application 110 of the script generation system 100 according to an example of the instant disclosure.

On selection of the user interface element in FIG. 3B, a modal user interface element shown in FIG. 4A may be displayed. When a user provides a command and selects a user interface element as shown in FIG. 4A, a command can be executed on the underlying virtual machine 106. The command output may be shown within the script generation application 110 alongside a diagramming tool that may allow the user to create the diagram. As a result, the user may execute a command on one or more virtual machines 106. In another example, the user may execute a script 150 within the diagramming tool of the script generation application 110.

When a user selects the “Deploy to AWS” user interface element, the graphical user interface 450 is displayed as shown in FIG. 4B. As shown in FIG. 4B, command execution details may be displayed.

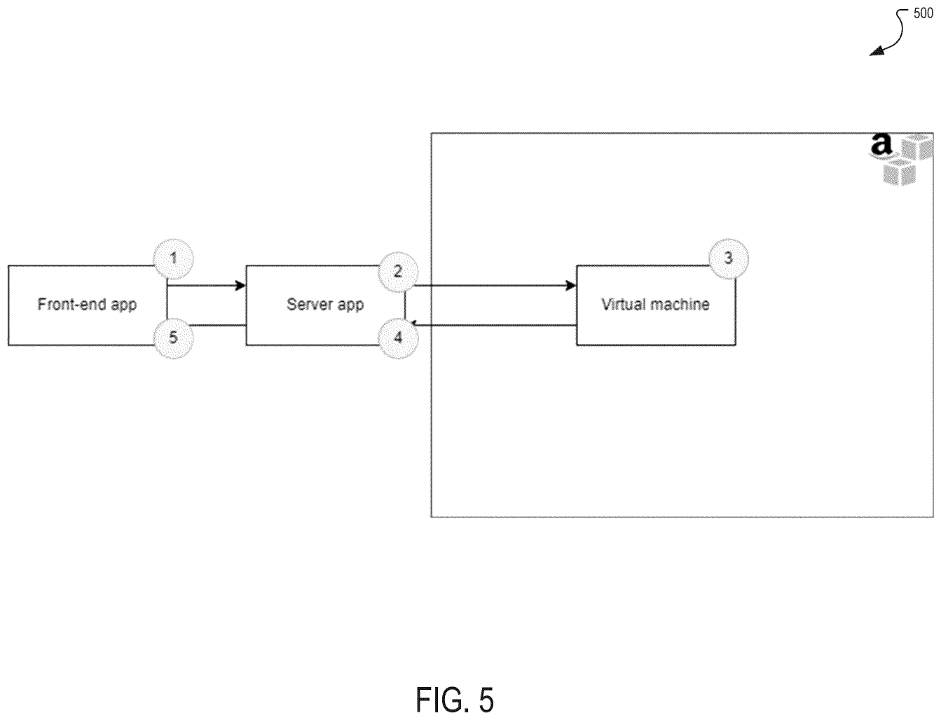

FIG. 5 shows another block diagram 500 of the script generation system 100 according to an example of the instant disclosure. As shown in FIG. 5, the user may use the front-end application or the component of the script generation application 110 executed by the client computing device 102. The at least one client computing device 102 is configured to receive data from and/or transmit data to the server application or the component of the script generation application executed by the server computing device 104. The server computing device 104 is configured to receive data and/or transmit data to the virtual machine 106. In one example, the virtual machine 106 may be associated with one or more cloud computing platforms such Amazon AWS, IBM Cloud, Google Cloud Platform, and Microsoft Azure, among others. As shown in FIG. 5, there may be an order to the communication such as from the front-end application to the server application to the virtual machine, to the server application, and back to the front-end application.

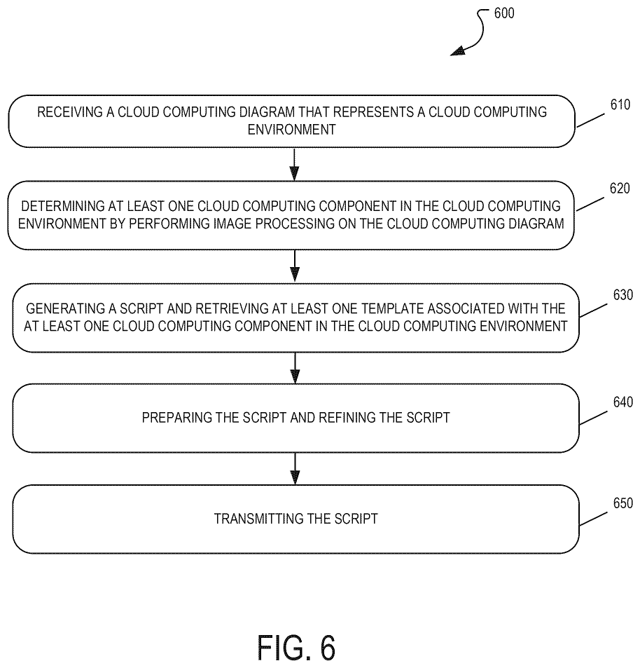

FIG. 6 shows a flowchart of a method 600 of generating a script 150 by the script generation system 100 according to an example of the instant disclosure. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 may include receiving, by at least one of the client computing device 102 and the server computing device 104, a cloud computing diagram that represents a cloud computing environment at block 610.

According to some examples, the method 600 may include determining, by one of the client computing device 102 and the server computing device 104, at least one cloud computing component in the cloud computing environment by performing image processing on the cloud computing diagram at block 620.

According to some examples, the method 600 may include generating, by one of the client computing device 102 and the server computing device 104, a script 150 and retrieving at least one template associated with the at least one cloud computing component in the cloud computing environment at block 630.

According to some examples, the method 600 may include preparing by one of the client computing device 102 and the server computing device 104, the script 150 and refining the script by ordering each of the at least one template based on user preferences at block 640.

According to some examples, the method 600 may include transmitting, from the server computing device 104 to the client computing device 102, the script 150 at block 650. In another example, the method 600 may include transmitting from the server computing device 104 to the virtual machine 106, the script.

According to some examples, the method 600 may include determining the at least one template by determining a particular cloud computing component to be in the cloud computing environment by performing the image analysis on the cloud computing diagram.

According to some examples, the method 600 may include inserting the at least one template in the script 150 for each of the at least one cloud computing component.

According to some examples, the method 600 may include converting the cloud computing diagram into one of XML data, JSON data, and Protobuf data, later developed data formats, and others.

According to some examples, the method 600 may include determining that a particular subset of the cloud computing diagram comprises one of a logo and a graphical representation and comparing the one of the logo and the graphical representation with a library to determine the at least one cloud computing component.

According to some examples, the method 600 may include transmitting a web application programming interface (API) request to at least one other server computing device to obtain the at least one template associated with the at least one cloud computing component in the cloud computing environment.

According to some examples, the method 600 may include receiving a selection of a user interface element and executing the script 150 by the client computing device 102 and displaying command output information associated with the script 150 while simultaneously displaying the cloud computing diagram that represents the cloud computing environment by the client computing device 102.

According to some examples, the method 600 may include displaying an execute command user interface element by the client computing device 102, receiving input comprising execute command information, transmitting the execute command information, and executing at least one command by the cloud computing environment.

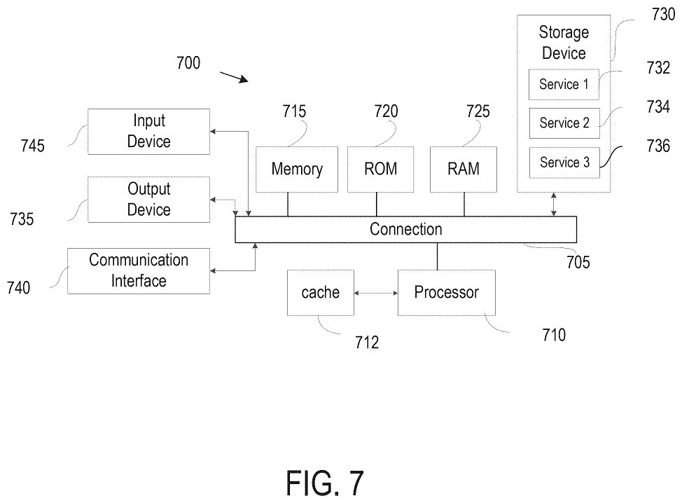

FIG. 7 shows an example of computing system 700, which can be for example the client computing device 102, the server computing device 104, the virtual machine 106, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A method comprising receiving, by at least one processor, a cloud computing diagram that represents a cloud computing environment, determining, by the at least one processor, at least one cloud computing component in the cloud computing environment by performing image processing on the cloud computing diagram, generating, by the at least one processor, a script and retrieving at least one template associated with the at least one cloud computing component in the cloud computing environment, preparing, by the at least one processor, the script and refining the script by ordering each of the at least one template based on user preferences, and transmitting, by the at least one processor, the script.

Aspect 2: The method of Aspect 1, further comprising determining the at least one template by determining a particular cloud computing component to be in the cloud computing environment by performing the image analysis on the cloud computing diagram.

Aspect 3: The method of Aspects 1 and 2, further comprising inserting the at least one template in the script for each of the at least one cloud computing component.

Aspect 4: The method of Aspects 1 to 3, further comprising converting the cloud computing diagram into at least one of XML data, JSON data, and Protobuf data.

Aspect 5: The method of Aspects 1 to 4, further comprising determining that a particular subset of the cloud computing diagram comprises one of a logo and a graphical representation and comparing the one of the logo and the graphical representation with a library to determine the at least one cloud computing component.

Aspect 6: The method of Aspects 1 to 5, further comprising transmitting a web application programming interface (API) request to at least one other server computing device to obtain the at least one template associated with the at least one cloud computing component in the cloud computing environment.

Aspect 7: The method of Aspects 1 to 6, further comprising transmitting the script to a client computing device.

Aspect 8: The method of Aspects 1 to 7, further comprising receiving a selection of a user interface element and executing the script by the client computing device and displaying command output information associated with the script while simultaneously displaying the cloud computing diagram that represents the cloud computing environment by the client computing device.

Aspect 9: The method of Aspects 1 to 8, further comprising displaying an execute command user interface element by the client computing device, receiving input comprising execute command information, transmitting the execute command information, and executing at least one command by the cloud computing environment.

Aspect 10: A system comprising a computing device comprising a memory storing computer-readable instructions and at least one processor to execute the instructions to receive a cloud computing diagram that represents a cloud computing environment, determine at least one cloud computing component in the cloud computing environment by performing image processing on the cloud computing diagram, generate a script and retrieve at least one template associated with the at least one cloud computing component in the cloud computing environment, prepare the script and refine the script by ordering each of the at least one template based on user preferences, and transmit the script.

Aspect 11: The system of Aspect 10, the at least one processor further to execute the instructions to determine the at least one template by determining a particular cloud computing component to be in the cloud computing environment by performing the image analysis on the cloud computing diagram.

Aspect 12: The system of Aspects 10 and 11, the at least one processor further to execute the instructions to insert the at least one template in the script for each of the at least one cloud computing component.

Aspect 13: The system of Aspects 10 to 12, the at least one processor further to execute the instructions to convert the cloud computing diagram into at least one of XML data, JSON data, and Protobuf data.

Aspect 14: The system of Aspects 10 to 13, the at least one processor further to execute the instructions to determine that a particular subset of the cloud computing diagram comprises one of a logo and a graphical representation and compare the one of the logo and the graphical representation with a library to determine the at least one cloud computing component.

Aspect 15: The system of Aspects 10 to 14, the at least one processor further to execute the instructions to transmit a web application programming interface (API) request to at least one other server computing device to obtain the at least one template associated with the at least one cloud computing component in the cloud computing environment.

Aspect 16: The system of Aspects 10 to 15, the at least one processor further to execute the instructions to transmit the script to a client computing device.

Aspect 17: The system of Aspects 10 to 16, the at least one processor further to execute the instructions to receive a selection of a user interface element and execute the script by the client computing device and display command output information associated with the script while simultaneously displaying the cloud computing diagram that represents the cloud computing environment by the client computing device.

Aspect 18: The system of Aspects 10 to 17, further comprising displaying an execute command user interface element by the client computing device, receiving input comprising execute command information, transmitting the execute command information, and executing at least one command by the cloud computing environment.

Aspect 19: A non-transitory computer-readable storage medium comprising instructions stored thereon that, when executed by a computing device cause the computing device to perform operations, the operations comprising receiving a cloud computing diagram that represents a cloud computing environment, determining at least one cloud computing component in the cloud computing environment by performing image processing on the cloud computing diagram, generating a script and retrieving at least one template associated with the at least one cloud computing component in the cloud computing environment, preparing the script and refining the script by ordering each of the at least one template based on user preferences, and transmitting the script.

Aspect 20: The non-transitory computer-readable storage medium of Aspect 19, the operations further comprising determining the at least one template by determining a particular cloud computing component to be in the cloud computing environment by performing the image analysis on the cloud computing diagram.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
receiving, by at least one processor, a cloud computing diagram that represents a cloud computing environment;
determining, by the at least one processor, at least one cloud computing component in the cloud computing environment by performing image processing on the cloud computing diagram;
generating, by the at least one processor, a script and retrieving at least one template associated with the at least one cloud computing component in the cloud computing environment;
preparing, by the at least one processor, the script and refining the script by ordering each of the at least one template based on user preferences; and
transmitting, by the at least one processor, the script.

2. The method of claim 1, further comprising:
determining the at least one template by determining a particular cloud computing component to be in the cloud computing environment by performing the image analysis on the cloud computing diagram.

3. The method of claim 1, further comprising inserting the at least one template in the script for each of the at least one cloud computing component.

4. The method of claim 1, further comprising converting the cloud computing diagram into at least one of XML data, JSON data, and Protobuf data.

5. The method of claim 1, further comprising determining that a particular subset of the cloud computing diagram comprises one of a logo and a graphical representation and comparing the one of the logo and the graphical representation with a library to determine the at least one cloud computing component.

6. The method of claim 1, further comprising transmitting a web application programming interface (API) request to at least one other server computing device to obtain the at least one template associated with the at least one cloud computing component in the cloud computing environment.

7. The method of claim 1, further comprising transmitting the script to a client computing device.

8. The method of claim 1, further comprising receiving a selection of a user interface element and executing the script by the client computing device and displaying command output information associated with the script while simultaneously displaying the cloud computing diagram that represents the cloud computing environment by the client computing device.

9. The method of claim 8, further comprising displaying an execute command user interface element by the client computing device, receiving input comprising execute command information, transmitting the execute command information, and executing at least one command by the cloud computing environment.

10. A system comprising:
a computing device comprising a memory storing computer-readable instructions; and
at least one processor to execute the instructions to:
receive a cloud computing diagram that represents a cloud computing environment;
determine at least one cloud computing component in the cloud computing environment by performing image processing on the cloud computing diagram;
generate a script and retrieve at least one template associated with the at least one cloud computing component in the cloud computing environment;
prepare the script and refine the script by ordering each of the at least one template based on user preferences; and
transmit the script.

11. The system of claim 10, the at least one processor further to execute the instructions to:
determine the at least one template by determining a particular cloud computing component to be in the cloud computing environment by performing the image analysis on the cloud computing diagram.

12. The system of claim 10, the at least one processor further to execute the instructions to insert the at least one template in the script for each of the at least one cloud computing component.

13. The system of claim 10, the at least one processor further to execute the instructions to convert the cloud computing diagram into at least one of XML data, JSON data, and Protobuf data.

14. The system of claim 10, the at least one processor further to execute the instructions to determine that a particular subset of the cloud computing diagram comprises one of a logo and a graphical representation and compare the one of the logo and the graphical representation with a library to determine the at least one cloud computing component.

15. The system of claim 10, the at least one processor further to execute the instructions to transmit a web application programming interface (API) request to at least one other server computing device to obtain the at least one template associated with the at least one cloud computing component in the cloud computing environment.

16. The system of claim 10, the at least one processor further to execute the instructions to transmit the script to a client computing device.

17. The system of claim 10, the at least one processor further to execute the instructions to receive a selection of a user interface element and execute the script by the client computing device and display command output information associated with the script while simultaneously displaying the cloud computing diagram that represents the cloud computing environment by the client computing device.

18. The system of claim 17, further comprising displaying an execute command user interface element by the client computing device, receiving input comprising execute command information, transmitting the execute command information, and executing at least one command by the cloud computing environment.

19. A non-transitory computer-readable storage medium comprising instructions stored thereon that, when executed by a computing device cause the computing device to perform operations, the operations comprising:
receiving a cloud computing diagram that represents a cloud computing environment;
determining at least one cloud computing component in the cloud computing environment by performing image processing on the cloud computing diagram;
generating a script and retrieving at least one template associated with the at least one cloud computing component in the cloud computing environment;
preparing the script and refining the script by ordering each of the at least one template based on user preferences; and
transmitting the script.

20. The non-transitory computer-readable storage medium of claim 19, the operations further comprising determining the at least one template by determining a particular cloud computing component to be in the cloud computing environment by performing the image analysis on the cloud computing diagram.
